(19) United States
(12) Patent Application Publication
(10) Pub. No.: US 2006/0268989 A1
(43) Pub. Date: Nov. 30, 2006

(54) BIT STREAM GENERATION METHOD AND BIT STREAM GENERATATION APPARATUS

(75) Inventors: Shinya KADONO, Osaka (JP); Aki YONEDA, Osaka (JP); Hisashi INOUE, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/420,509

(22) Filed: May 26, 2006

Related U.S. Application Data
(60) Provisional application No. 60/684,967, filed on May 27, 2005.
(60) Provisional application No. 60/684,968, filed on May 27, 2005.

(51) Int. Cl. H04N 11/04

(52) U.S. Cl. 375/240.23

(57) ABSTRACT

A bit stream generation apparatus includes: an analysis unit which specifies, for each overlay position, an overlay position for overlaying, onto the first bit stream, respective bits of supplementary information which is a bit string, and also specifies replacement data for the replacement in accordance with the supplementary information, by analyzing a data structure of a first bit stream; a transformation table creation unit which creates a transformation table indicating the overlay position and the replacement data specified by the analysis unit; and an adding unit which generates a second bit stream by adding, to the first bit stream, the transformation table created by the transformation table creation unit.

### CROSS REFERENCE TO RELATED APPLICATION(S)

This application claims the benefit of U.S. Provisional Applications No. 60/684967 and No. 60/684968 which are filed May 27, 2005, the contents of which are herein incorporated by reference in its entirety.

### BACKGROUND OF THE INVENTION

(1) Field of the Invention

The present invention relates to a bit stream generation method and a bit stream generation apparatus for generating a bit stream.

(2) Description of the Related Art

Recently, with the arrival of the age of multimedia in which audio, video and other pixel values are integrally handled, existing information media, i.e., newspapers, journals, TVs, radios and telephones and other means through which information is conveyed to people has come under the scope of multimedia. Generally speaking, multimedia refers to something that is represented by associating not only characters but also graphics, audio and especially images and the like together. However, in order to include the aforementioned existing information media in the scope of multimedia, it appears as a prerequisite to represent such information in digital form.

However, when estimating the amount of information contained in each of the aforementioned information media as the amount of digital information, the information amount per character requires 1-2 bytes whereas the audio requires more than 64 Kbits (telephone quality) per second, and when it comes to the moving picture, it requires more than 100 Mbits (present television reception quality) per second. Therefore, it is not practical to handle the vast information directly in the digital format via the information media mentioned above. For example, a videophone has already been put into practical use via Integrated Services Digital Network (ISDN) with a transmission rate of 64 Kbit/s-1.5 Mbit/s, however, it is not practical to transmit video captured on the TV screen or shot by a TV camera.

This therefore requires information compression techniques, and for instance, in the case of the videophone, video compression techniques compliant with H.261 and H.263 standards recommended by ITU-T (International Telecommunication Union-Telecommunication Standardization Sector) are employed. According to the information compression techniques compliant with the MPEG-1 standard, image information as well as music information can be stored in an ordinary music CD (Compact Disc).

Here, MPEG (Moving Picture Experts Group) is an international standard for compression of moving picture signals standardized by ISO/IEC (International Standards Organization/International Electrotechnical Commission), and MPEG-1 is a standard to compress video signals down to 1.5 Mbit/s, that is, to compress information of TV signals approximately down to a hundredth. The transmission rate within the scope of the MPEG-1 standard is set to about 1.5 Mbit/s to achieve the middle-quality picture, therefore, MPEG-2 which was standardized with the view to meet the requirements of high-quality picture allows data transmission of moving picture signals at a rate of 2-15 Mbit/s to achieve the quality of TV broadcasting. In the present circumstances, a working group (ISO/IEC JTC1/SC29/WG11) in the charge of the standardization of the MPEG-1 and the MPEG-2 has achieved a compression rate which goes beyond what the MPEG-1 and the MPEG-2 have achieved, further enabled encoding/decoding operations on a per-object basis and standardized MPEG-4 in order to realize a new function required by the era of multimedia. In the process of the standardization of the MPEG-4, the standardization of encoding method for a low bit rate was aimed, however, the aim is presently extended to a more versatile encoding of moving pictures at a high bit rate including interlace pictures. At present, MPEG-4 AVC and ITU-TH.264 have been standardized as a next generation picture coding scheme with higher compression rate, which are jointly worked by the ISO/IEC and the ITU-T.

The MPEG-2 is presently used in a wide range of applications such as a Digital Versatile Disk (DVD), a digital broadcasting and the like. In the future, however, it is expected that the MPEG-4 AVC with high compression rate will be used in place of the MPEG-2.

On the other hand, right management with regard to copyrighted works has recently gained attention. A digital content can be easily duplicated so as to make a copy just as same as the original one, therefore, protection of copyright of content is a crucial issue. Since there is not much difference between a content illegally copied or distributed and the original content, it is difficult to show evidence that asserts the copyright of content, and methods for protecting copyright are under the study.

For example, in the case where a stream is illegally distributed, it is possible for a decoder which has reproduced or received a stream coded based on the MPEG-2 and the MPEG-4 AVC to identify the distributor of the decoder, by recording supplementary information such as identification information for identifying the decoder which has reproduced or received the stream.

A stream on which supplementary information is recorded is decoded by a decoder, therefore, the stream should be compliant with the MPEG standards irrespective of the presence/absence of supplementary information. Therefore, in most of the cases, frequency transformation (DCT transformation) is performed onto pixel values, and then the supplementary information is overlaid onto quantized values which are quantized.

For example, it is assumed that the supplementary information requires 8 bits. Xᵢ (i is an integer ranged from 0 to 7) here presents 0 or 1. The quantized values of the high frequency components, which are the most difficult ones among the DCT transformed coefficients to recognize visual change, are extracted from eight blocks (Qᵢ denotes the high frequency components of the i th block), and Qᵢ+Xᵢ denotes the quantized values of the high frequency components of the new i th block.

Thus, by changing, with the decoder, the quantized values of the MPEG stream into values corresponding to the supplementary information, it is possible to generate an MPEG stream on which the supplementary information of 8 bits is overlaid while maintaining the stream to be compliant with the MPEG standards.

However, overlaying the supplementary information onto a stream as described above may lead to an increase in the file size of the stream generated after the overlay. When storing and distributing the stream, the change in the file size causes problems such as not being able to store the stream into a predetermined size or not being able to distribute the stream within the speed rate of a communication line.

### SUMMARY OF THE INVENTION

The present invention is therefore conceived in view of the above problems, and an object of the present invention is to provide a bit stream generation method and a bit stream generation apparatus capable, even though the supplementary information is overlaid onto a bit stream, of generating a bit stream that enables the overlay of the supplementary information in the following manner: without changing the amount of coded data at all, as compared with the original stream; without affecting an existing decoding process; and by which it is hard to perceive degradation in picture quality.

In order to achieve the above object, a bit stream generation method according to the present invention is a bit stream generation method for generating a bit stream, and includes: creating transformation information indicating a position for overlaying, onto a first bit stream resulting from coding of data, respective bits of supplementary information which is a bit string, the position being a position at which it is determined whether or not data is to be replaced, according to the respective bits of the supplementary information; and generating a second bit stream by adding the generated transformation information to the first bit stream.

Thus, even though the supplementary information is overlaid onto the first bit stream, it is possible to generate a bit stream which enables the overlay of the supplementary information without neither changing the amount of coded data at all as compared with the original bit stream nor affecting the existing decoding process. In addition, it is possible to generate a bit stream which realizes the overlay of the supplementary information, by which degradation in picture quality can be reduced.

The replacement data may be specified per position by analyzing a data structure of the first bit stream. The replacement data here may replace data in accordance with the position and the supplementary information, and have a code length which does not change through the replacement. The replacement data and the information indicating the specified position may be created as the transformation information.

The first bit stream may be variable-length coded, and a position, in variable-length coding, of the coded data having a same run length, a different level and a same code length may be specified as the position by analyzing a data structure of the first bit stream, and the coded data of a same run length, a different level and a same code length as compared with the coded data located in the specified position may be specified as the replacement data.

The first bit stream is variable-length coded, and the position, in variable length coding, of the coded data having a same level, a different run length and a same code length may be specified as the position by analyzing the data structure of the first bit stream, and the coded data having a same level, a different run length and a same code length as compared with the coded data located in the specified position may be specified as the replacement data,

A stuff bit may be changed to a longer stuff bit which is added to a predetermined unit including the position so that the predetermined unit reaches a pre-set code length. The second bit stream may be generated by adding the changed first bit stream to the transformation information. Thus, it is possible to generate a bit stream which realizes the overlay of the supplementary information without neither changing the amount of coded data at all as compared with the original first bit stream (the first bit stream including a stuff bit) nor affecting the existing decoding process. In addition, it is possible to generate a bit stream which realizes the overlay of the supplementary information, by which degradation in picture quality can be reduced.

The predetermined unit which includes a stuff bit of a predetermined threshold or greater may be specified as the position, by analyzing the data structure of the first bit stream. The stuff data here may be added so that the predetermined unit reaches a pre-set code length. The information indicating the specified position may be created as the transformation information. Thus, even in the case where the supplementary information is overlaid onto the first bit stream without newly adding a stuff bit, it is possible to generate a bit stream which realizes the overlay of the supplementary information without nor changing the amount of coded data at all as compared with the original first bit stream, nor affecting the existing decoding process.

Moreover, the present invention can be realized not only as such bit stream generation method, but also as a bit stream generation apparatus which includes, as units, the characteristic steps included in the bit stream generation method, and even as a program which causes a computer to execute these steps. Needless to say, such program can be distributed via a storage medium such as a CD-ROM and a transmission medium such as the Internet.

According to the bit stream generation method and the bit stream generation apparatus of the present invention, even in the case where the supplementary information is overlaid onto the first bit stream without newly adding a stuff bit, it is possible to generate a bit stream which realizes the overlay of the supplementary information without nor changing the amount of coded data at all, as compared with the original first bit stream, nor affecting the existing decoding process. Also, it is possible to generate a bit stream that realizes the overlay of the supplementary information, by which degradation in picture quality can be reduced.

### FURTHER INFORMATION ABOUT TECHNICAL BACKGROUND TO THIS APPLICATION

The disclosure of U.S. Provisional Applications No. 60/684967 and No. 60/684968 which are filed May 27, 2005, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of the bit stream generation apparatus which realizes the bit stream generation method according to a first embodiment;

FIG. 2 is a diagram showing zigzag scanning performed in DCT transformation;

FIG. 3 shows an example of a Huffman table;

FIG. 4 shows an example of a transformation table according to the first embodiment;

FIG. 5 is a flowchart showing the operation of the bit stream generation apparatus according to the first embodiment;

FIG. 6 is a block diagram showing a variation of the structure of the bit stream generation apparatus according to the first embodiment;

FIG. 7 is a block diagram showing a structure of the reproduction apparatus which reproduces the storage medium according to the first embodiment;

FIGS. 8A and 8B show DCT transformation of blocks: FIG. 8A shows the state before replacement of Huffman code; and FIG. 8B shows the state after the replacement of the Huffman code;

FIG. 9 is a block diagram showing the structure of the bit stream generation apparatus which realizes the bit stream generation method according to a second embodiment;

FIG. 10 is an illustration showing an example of the data structure of a bit stream;

FIG. 11 is an illustration showing a detailed example of the data structure of a slice;

FIGS. 12A, 12B and 12C are diagrams for describing a stuff bit: FIG. 12A shows the state before a redundant stuff bit is added;

FIG. 12B shows the state after the redundant stuff bit is added; and

12C shows the state after the Huffman code is replaced;

FIG. 13 is an illustration showing an example of the data structure of a picture;

FIG. 14 is a diagram showing syntax of the slice headers according to MPEG-4 AVC;

FIG. 15 is a diagram summarizing the meanings indicated by slice_type;

FIG. 16 is a diagram showing syntax of the macroblock according to the MPEG-4 AVC;

FIGS. 17A and 17B are diagrams showing examples of the relationship between ref_index0 and reference pictures;

FIG. 18 is a diagram showing the detailed data structure of ref_pic_list_reordering( );

FIG. 19 is a diagram showing an example of ref_pic_list_reordering( );

FIG. 20 is a diagram showing another example of ref_pic_list_reordering( );

FIG. 21 is a diagram showing an example of the data structure of the slice of an MPEG-2 video stream;

FIGS. 22A and 22B are diagrams showing examples of the data structure of the slice of the MPEG-2 video stream.

### DESCRIPTION OF THE PREFERRED EMBODIMENT(S)

### First Embodiment

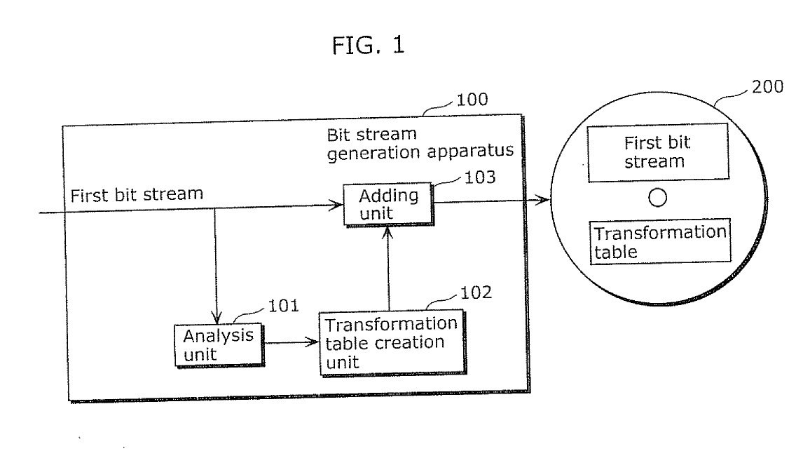

FIG. 1 is a block diagram showing a structure of the bit stream generation apparatus which realizes the bit stream generation method according to the first embodiment of the present invention.

A bit stream generation apparatus 100 is an apparatus which generates a second bit stream by adding a transformation table to a first bit stream to be inputted, and includes an analysis unit 101, a transformation table creation unit 102 and an adding unit 103, as shown in FIG. 1.

The first bit stream is obtained by performing compressive coding onto image data so as to be transformed into variable length coded bit stream, and is a bit stream coded, for example, by MPEG-2, MPEG-4 AVC or the like. In other words, first, image data is divided into blocks of a predetermined size (8×8 pixels in the present embodiment), and a Discrete Cosine Transformation is executed. Next, the DCT transformed frequency coefficients (DC coefficients and AC coefficients) are quantized by a quantization step which is derived from a quantization parameter table, so as to obtain the quantized values.

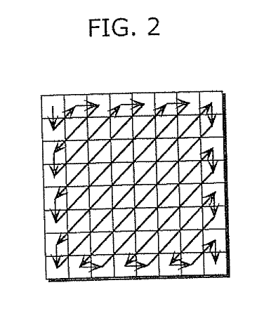

The quantized values of the AC coefficients are variable-length coded (Huffman coded) to be made up of the number (RUN) of consecutive zero values and a quantized value of a non-zero value (LEVEL) which are obtained as a result of the zigzag scanning as shown in FIG. 2.

The analysis unit 101 specifies, for each overlay position, an overlay position for overlaying, onto the first bit stream, the respective bits of the supplementary information which is a bit string and also specifies the replacement data for the replacement, in accordance with the supplementary information, by analyzing the data structure of the first bit stream.

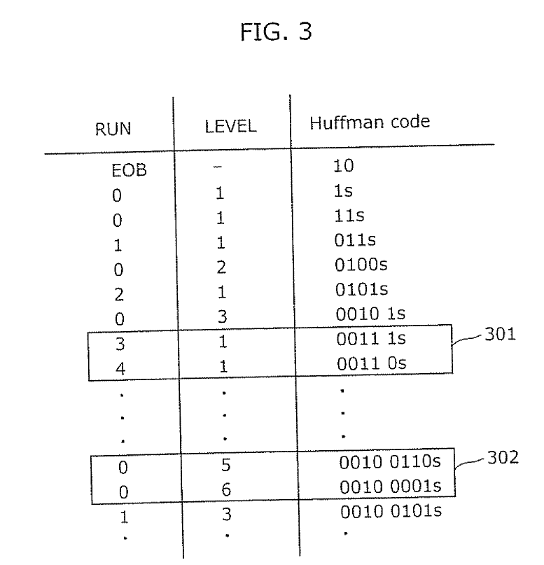

In the case of overlaying the supplementary information onto the bit stream as described above, it is preferable to embed the information into the higher components of the AC coefficients in order to reduce quality degradation. In this case, the Huffman coding uses, for instance, a Huffman table as shown in FIG. 3, which is created based on apparition probability of RUN+LEVEL. The last bit s denotes a code of LEVEL: if “0”, the code is positive; and if “1”, the code is negative. Normally, the code length differs as the combination of RUN+LEVEL varies. However, in the case of slightly changing RUN or LEVEL, the code length may be the same. For example, there are pairs 301 and 302 of the Huffman codes having the same code length, as shown in FIG. 3. The pair 301 has the same LEVEL and a RUN different by 1. The pair 302 has the same RUN and a LEVEL different by 1. In such case, the code amount of the bit stream does not change even though the original code length is replaced with the code length of the slightly-changed RUN+LEVEL. In addition, it is possible to reduce degradation in picture quality since the value is changed only by +1. Moreover, since the replacement is performed using the code length presented in the Huffman table, the bit stream is compliant with the MPEG standards and it does not affect the existing decoding process.

The analysis unit 101 specifies, as the overlay position for overlaying the respective bits of the supplementary information, the position where either of the following Huffman codes is located: a Huffman code of the pair having the same LEVEL, a RUN different by 1 and the same code length; and a Huffman code of the pair having the same RUN, a LEVEL different by 1 and the same code length. The analysis unit 101 then specifies, as replacement data, the other Huffman code of the same pair having the same code length as that of the Huffman code located in the specified position. For example, in the case where the specified position of the Huffman code is “00100110s” having a RUN “0” and a LEVEL “5” the analysis unit 101 specifies the Huffman code “00100001s” of a RUN “0” and a LEVEL “6”, as replacement data, Note that it is preferable to change only RUN in the case of RUN for coding the highest frequency components of the block, since in the case the RUN is changed, the frequency position of the following quantized values resulting from zigzag scanning may be changed as well.

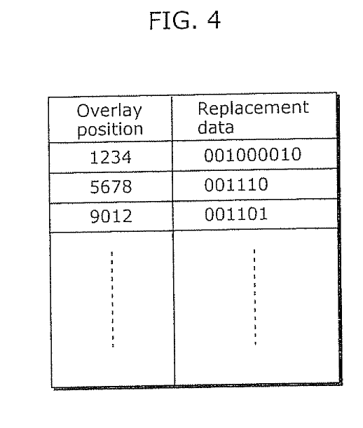

The transformation table creation unit 102 creates a transformation table (transformation information) indicating the overlay position and the replacement data which are specified by the analysis unit 101. For example, the replacement data corresponding to each overlay position is described in the transformation table as shown in FIG. 4.

The adding unit 103 generates a second bit stream by adding, to the first bit stream, the transformation table created by the transformation table creation unit 102. In this case, it is preferable, in a random-accessible storage medium, that the adding unit 103 generates a second bit stream in such a way that the second bit stream has the structure in which the first bit stream and the transformation table are included separately, instead of adding the transformation table into the first bit stream. The generated second bit stream is stored into a storage medium 200 such as a DVD. In the application, such as a communication where random access cannot be performed, the transformation table may be added into the fist bit stream.

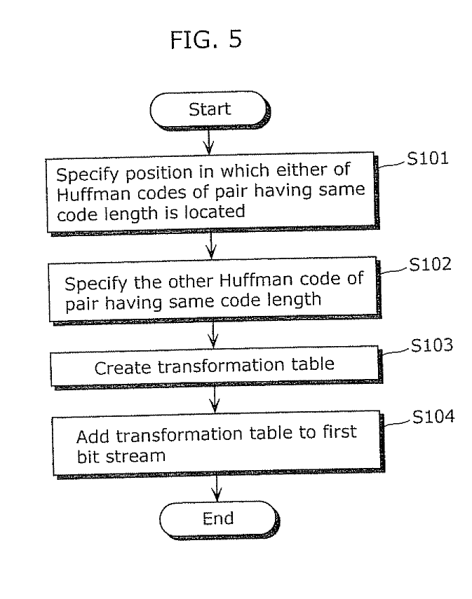

The operation of the bit stream generation apparatus having the structure as described above will be described below. FIG. 5 is a flowchart showing the operation of the bit stream generation apparatus.

The analysis unit 101 specifies, as the overlay position for overlaying the respective bits of the supplementary information which is a bit string onto the first bit stream, by analyzing the data structure of the inputted first bit stream, the position where either of the following Huffman codes is located: a Huffman code of the pair having the same LEVEL, a RUN different by 1 and the same code length; and a Huffman code of the pair having the same RUN, a LEVEL different by 1 and the same code length (Step S101). The analysis unit 101 specifies, as the replacement data, the other Huffman code of the same pair having the same code length as that of the Huffman code located in the specified position (Step S102). Then, the transformation table creation unit 102 creates a transformation table indicating the overlay position and the replacement data which are specified by the analysis unit 101 (Step 103). Then, the adding unit 103 generates a second bit stream by adding, to the first bit stream the transformation table created by the transformation table creation unit 102 (Step S104).

As described above, the transformation table indicating the replacement data and the overlay position having the code length that will not change is created, and then the transformation table is added into the first bit stream, therefore, it is possible to generate a bit stream that realizes the overlay of the supplementary information without changing at all the amount of coded data as compared with the original first bit stream, and without affecting the existing decoding process. Also, it is possible to generate a bit stream that realizes the overlay of the supplementary information which can reduce degradation in picture quality.

It should be noted that, in the present embodiments the analysis unit 101 specifies, as the overlay position, either of the positions of the Huffman codes of the pair having the same LEVEL, a RUN different by 1 and the same code length; either of the positions of the Huffman codes of the pair having the same RUN, a LEVEL different by 1 and the same code length. The present invention, however, is not limited to this. For example, the analysis unit 101 may specify, as the overlay position, only either of the positions of the Huffman codes of the pair having the same LEVEL, a RUN different by 1 and the same code length. Or the analysis unit 101 may specify only either of the positions of the Huffman codes of the pair having the same RUN, a LEVEL different by 1 and the same code length. In addition, the analysis unit 101 may specify only either of the positions of the Huffman codes of the pair having LEVEL and RUN different by 1 and the same length code. More over, the analysis unit 101 may specify only either of the positions of the Huffman codes of the pair having LEVEL and RUN which are respectively different by 2 and the same code length.

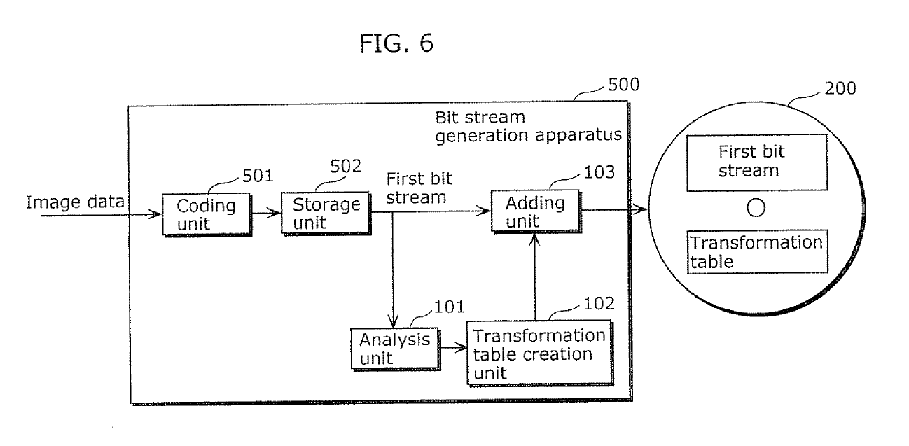

The present embodiment describes the structure in which a bit stream (first bit stream) is inputted, however, the present invention is not limited to this. For example, the structure may be the one in which a second bit stream is generated by adding a transformation table into a first bit stream after the generation of the first bit stream through the coding process when the image data is inputted, as shown in FIG. 6. In such case, the coding unit 501 performs coding based, for instance, on the MPEG-2 and the MPEG-4 AVC. The storage unit 502 stores the first bit stream coded by the coding unit 501.

Next, the case of reproducing a storage medium 200 in which the second bit stream generated as described above is stored will be described.

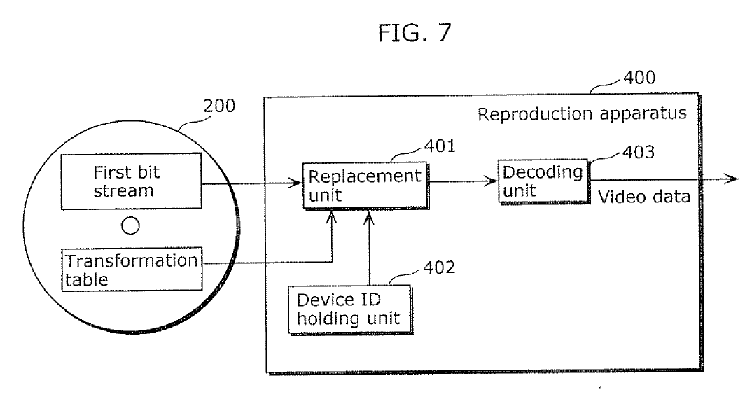

FIG. 7 is a block diagram showing the structure of the reproduction apparatus which reproduces the storage medium 200.

A reproduction apparatus 400 is an apparatus which reproduces the second bit stream which is made up by the first bit stream and the transformation table and is stored in the storage medium 200, and includes a replacement unit 401, a device ID holding unit 402 and a decoding unit 403.

The device ID holding unit 402 holds a device ID that is uniquely assigned to the reproduction apparatus 400.

The replacement unit 401 reads out the transformation table from the storage medium 200 when the reproduction apparatus 400 reproduces the second bit stream, that is, the first bit stream. The replacement unit 401 obtains a device ID from the device ID holding unit 402. Moreover, the replacement unit 401 reads out the first bit stream from the storage medium 200, and overlays, onto the readout first bit stream, the bit string indicating the device ID using the transformation table. That is to say that when the bit value of the device ID of the device to be overlaid onto the position indicated by the transformation table indicates “0”, the replacement unit 401 does not replace the data located in the overlay position indicated by the transformation table, and when the bit value indicates “1”, the replacement unit 401 replaces the data with the replacement data indicated by the transformation table.

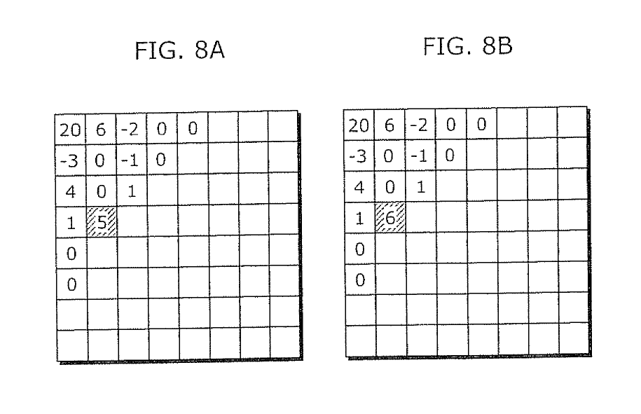

For example, assuming that one of the overlay positions of the supplementary information indicated by the transformation table is the one having the LEVEL value “5” of the AC coefficient indicated by a hatched part in the DCT coefficients of the block, as shown in FIG. 8A, and the replacement data is “001000010”. In this case, RUN of the first bit stream indicates “0”, therefore, the stream is coded with 9 bits of Huffman codes=“001001100) as referred to the Huffman table shown in FIG. 3. Here, when the bit value of the device ID of the device to be overlaid onto the indicated position indicates “0”, the value “001001100” shall not be changed, but when the bit value indicates “1”, the data is replaced by the replacement data “001000010”.

In this case, the first bit stream replaced with the replacement data “001000010” means that the LEVEL value of the AC coefficient indicated by a hatched part is replaced with “6”, as shown in FIG. 8B, however, the code length is as same as that of the original first bit stream.

The decoding unit 403 decodes the first bit stream onto which the device ID is overlaid, using, for instance, the MPEG-2 and the MPEG-4 AVC, and outputs the video data.

As described above, since the bit string indicating the device ID is overlaid onto the first bit stream using the transformation table, it is possible to overlay the bit string indicating the device ID without changing the amount of coded data as compared with the original first bit stream. Also, since the data is replaced with the codes presented in the Huffman table, it is possible to output the video data using the existing decoding process. Moreover, RUN or LEVEL is slightly changed, therefore, it is possible to reduce degradation in picture quality.

On the other hand, in the case of extracting the supplementary information onto which the first bit stream is overlaid, it is possible to detect a bit “1” if the Huffman codes are different, and a bit “0” if the Huffman codes are the same, through the comparison between the Huffman codes with regard to each overlay position of the original first bit stream and the Huffman codes with regard to each overlay position of the first bit stream onto which the supplementary information has been overlaid.

Note that, in the present embodiment, the replacement unit 401 does not perform the replacement with the replacement data if the bit value of the device ID to be overlaid is “0”, and performs the replacement if the bit value is “1”, however, the present invention is not limited to this. On the contrary, it may be defined that if the bit value is “0”, the data is replaced with the replacement data and if the bit value is “1”, the replacement with the replacement data is not performed.

Also, in the present embodiment, the replacement unit 401 overlays a device ID, but the present invention is not limited to this, and other information may be overlaid instead.

### Second Embodiment

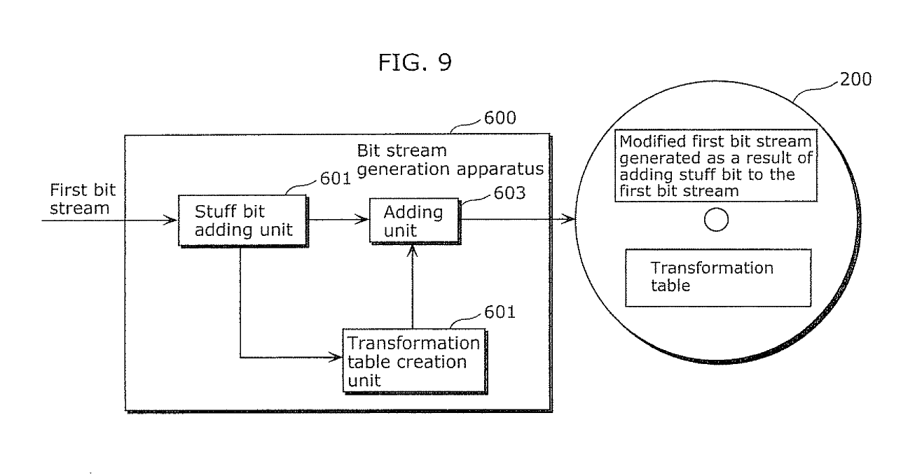

FIG. 9 is a block diagram showing the structure of the bit stream generation apparatus which realizes the bit stream generation method according to the second embodiment of the present invention.

The bit stream generation apparatus 600 is an apparatus which generates a second bit stream by adding the inputted first bit stream into the transformation table, and includes a stuff bit adding unit 601, a transformation table creation unit 602 and an adding unit 603.

The stuff bit adding unit 601 adds a stuff bit of a predetermined unit (e.g., units of 8 bits) to the end of a pre-set slice which is an overlay position for overlaying, onto the first bit stream, the respective bits of the supplementary information which is a bit string.

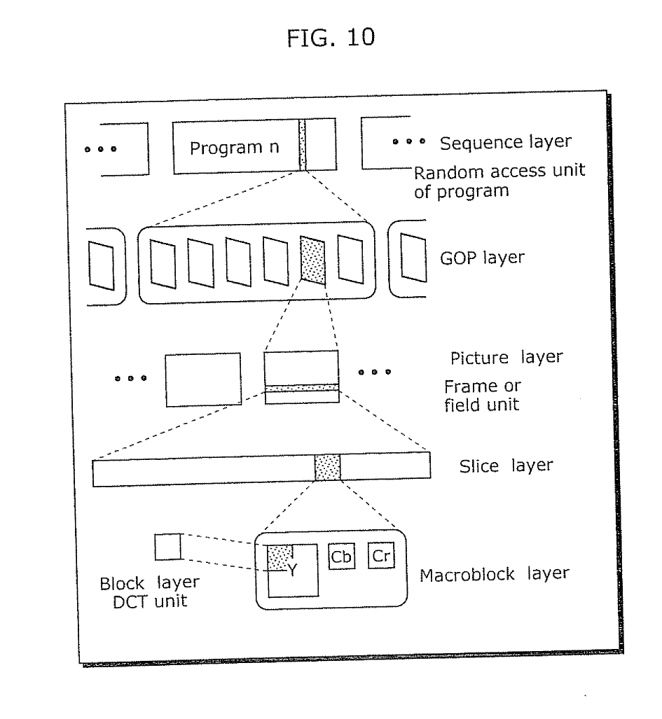

FIG. 10 is an illustration indicating an example of the data structure of a bit stream. As shown in FIG. 10, the bit stream has a hierarchical structure as shown in the following. The bit stream is made up of plural Group Of Pictures. By using Group Of Picture as a basic unit of coding, editing of moving pictures and random access are made possible. The Group Of Picture consists of plural pictures. Each picture is further divided into slices. A slice is a band-like region within each picture, and is made up of plural macroblocks. A macroblock is made up of plural blocks, each being a unit of Discrete Cosine Transformation (DCT Transformation).

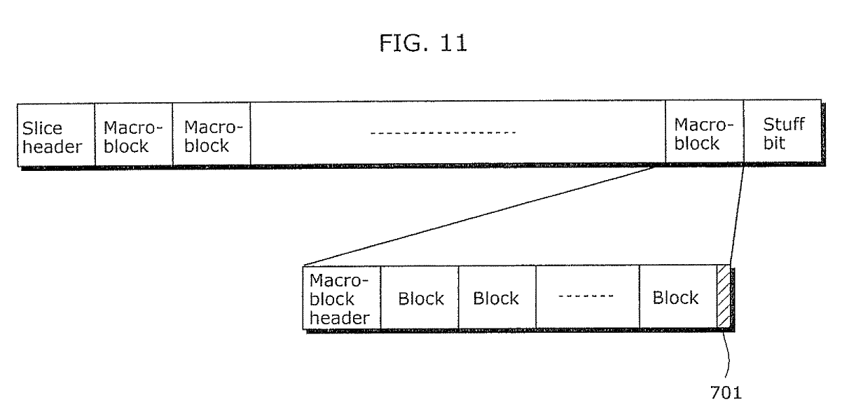

FIG. 11 is an illustration showing the details of the example of the data structure of a slice.

The slices constitute a bit stream in predetermined units (e.g. units of 8 bits), therefore, padding is performed by embedding a stuff bit so that the slice is of a predetermined unit, after the last LEVEL 701 of the AC coefficient of the last block of the last macroblock of the slice. The stuff bit may be an arbitrary number of bits providing that the stream is transmitted in predetermined units.

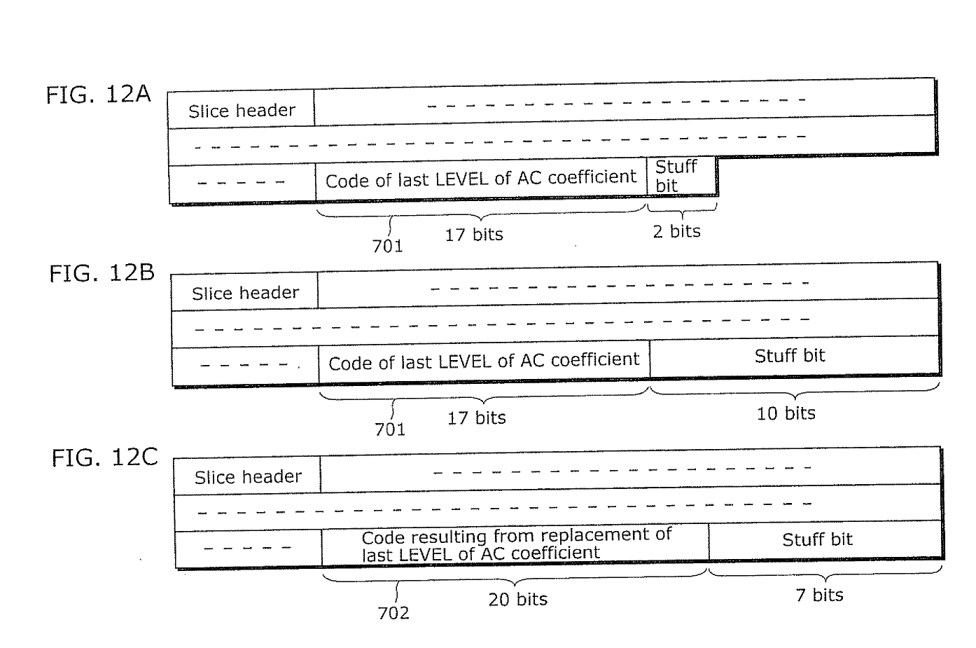

For example, assuming that it requires 2 bits after the last AC coefficient 701 in order that the stream is transmitted in predetermined units, padding is performed by embedding a stuff bit of 2 bits as shown in FIG. 12A.

The stuff bit adding unit 601 adds a stuff bit of a predetermined unit (here 8 bits) in addition to the 2 bits. Thus, the stuff bit embedded into the slice amounts to 10 bits as shown in FIG. 12B. Here, the last LEVEL 701 of the AC coefficient of the last block of the slice is changed and then replaced for overlaying the supplementary information, in the case where the replacing code length is larger than the code length of the original AC coefficient by 3 bits, it is possible to perform replacement without affecting the total code length by performing padding by embedding a stuff bit of 7 bits as shown in FIG. 12C.

The transformation table creation unit 602 creates a transformation table indicating a pre-set slice to which a stuff bit has been added by the stuff bit adding unit 601.

The adding unit 603 generates a second bit stream by adding the transformation table created by the transformation table creation unit 602 to a modified first bit stream generated as a result of adding a stuff bit to the first bit stream. Here, the adding unit 603 generates the second bit stream so that the stream separately includes the modified first bit stream and the transformation table, instead of adding the transformation table into the modified first bit stream. The generated second bit stream is stored into the storage medium 200 such as a DVD.

Thus, a stuff bit is added, a transformation table indicating the overlay position at which the stuff bit has been added is created, and the transformation table is added to the modified first bit stream resulting from the addition of the stuff bit to the first bit stream, it is possible to generate a bit stream which realizes the overlay of the supplementary information without neither changing at all the amount of coded data as compared with the modified first bit stream nor affecting the existing decoding process, even though the supplementary information is overlaid onto the first bit stream to which the stuff bit has been added. Also, it is possible to generate a bit stream which realizes the overlay of the supplementary information by which it is possible to reduce degradation in picture quality.

It should be noted that, in the present embodiment, a stuff bit is added to the end of a pre-set slice, however, the present invention is not limited to this. For example, by analyzing the data structure of the first bit stream, a slice that includes a predetermined number of stuff bit (e.g., 6 bits) or more may be specified so that the transformation table indicating such slice may be created. Thus, it is possible to generate a bit stream which realizes the overlay of the supplementary information without neither newly adding a stuff bit, nor changing the amount of coded data as compared with the original first bit stream nor affecting the existing decoding process even though the supplementary information is overlaid to the first bit stream.

### Third Embodiment

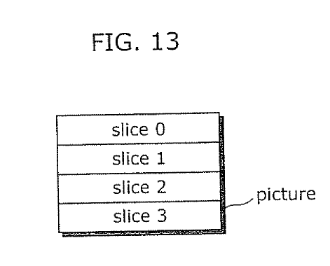

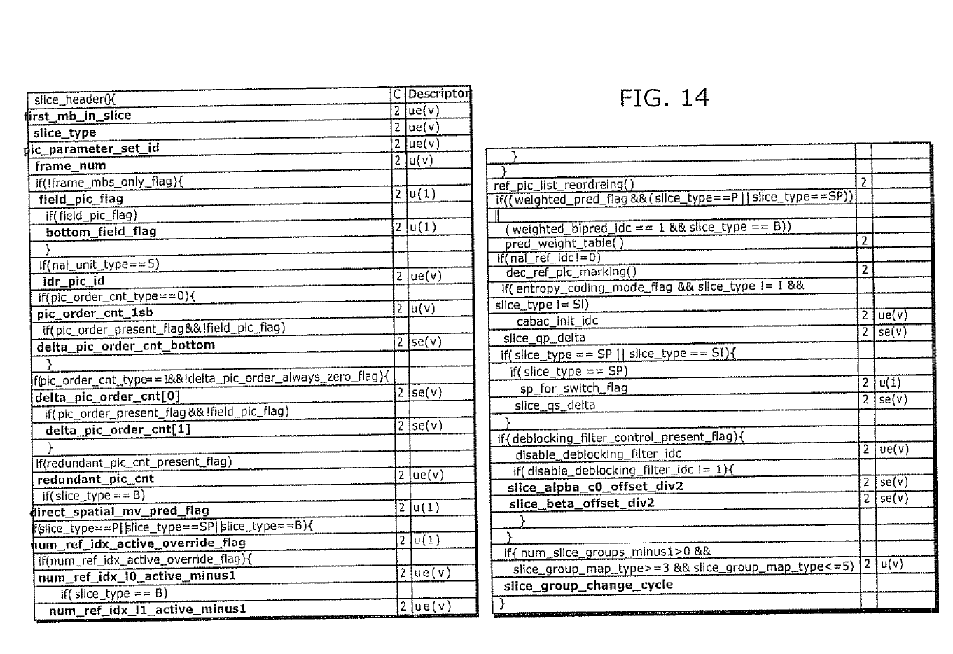

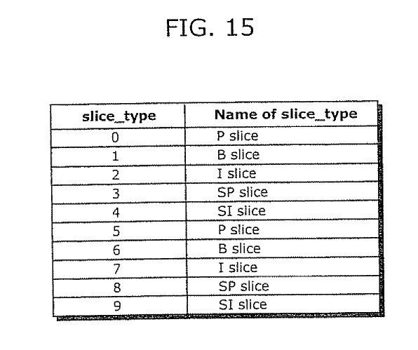

FIG. 13 is an illustration showing an example of the data structure of a picture, while FIG. 14 is a diagram showing syntax of slice headers according to the MPEG-4 AVC. As described above, one picture of the bit stream is composed of one or more slices as shown in FIG. 13, and a slice header is provided to the head of each slice as shown in FIG. 11. Among the syntax of the slice header, slice_type is a syntax that indicates what kind of coding is performed to the slice. FIG. 15 is a diagram summarizing the meanings indicated by slice_type.

Here, “I slice” is a slice composed only of intra-picture coded macroblocks, “P slice” is a slice composed of intra-picture coded macroblocks and macroblocks which are unidirectionally inter-picture predictive coded, “B slice” is a slice composed of intra-picture coded macrobiocks, macroblocks which are unidirectionally inter-picture predictive coded, and macroblocks which are bi-directionally inter-picture predictive coded, “SI slice” is a picture that can switch a stream and is also an I slice, and “SP slice” is a picture that can switch a stream and is also a P slice.

Moreover, in FIG. 15, the names of two “slice_type”; one with slice_type=N (N is an integer between 0 and 4) and the other with slice_type=N+5, are the same, however, when “slice type_equals to a number between 0 and 4, it shows that plural “slice_type” may be mixed in one picture, whereas when “slice_type” equals to a number between 5 and 9, it shows that all the “slice_type” included in one picture are the same.

In the normal case of coding a picture using the MPEG-4 AVC in order to record the picture into a storage media, since it is sufficient to use only one type of “slice_type” for one picture, “slice_type” numbered between 5 and 9 is used in many cases. On the other hand, in the application where data can easily disappear due to error in transfer such as wireless transfer, “slice_type” numbered between 0 and 4 is used, in many cases, so that any picture may include “I slice” with little degradation in quality in case of transfer error.

In the storage media, however, even though only one type of “slice_type” is used for one picture, the use of “slice_type” numbered between 0 and 4 does not go against the MPEG standards.

It is therefore possible to overlay the supplementary information (X₀, X₁, X₂, X₃, X₄, X₅, X₆, X₇) onto eight slice headers as shown below.

\textcircled{1} When the supplementary information Xᵢ (i is an integer ranged between 0 and 7) indicates 0, the “slice_type” of the I th slice with any number of 0 to 4 shall be used.

\textcircled{2} When the supplementary information Xᵢ (i is an integer ranged between 0 and 7) indicates 1, the “slice_type” of the I th slice with any number of 5 to 9 shall be used.

In other words, when Xᵢ indicates 0, slice_type=N is defined whereas when Xᵢ indicates 1, slice_type=N+5 is defined (N is an integer between 0 and 4), so as to generate a stream. Thus, even though the values of “slice_type” of the slice headers of the MPEG stream are different, when the streams except for the slice headers are totally the same, it is obvious that the decoded pictures correspond to each other irrespective of the value indicative of the supplementary information and whether the supplementary information is overlaid or not.

Thus as described above, in order to obtain supplementary information from the stream on which the supplementary information is overlaid, it is possible to easily extract the supplementary information as in the following: when “slice_type” of each slice is between 0 and 4, the corresponding supplementary information shall indicate 0; and when “slice_type” is between 5 and 9, the corresponding information shall indicate 1.

### Fourth Embodiment

The codes “num_ref_idx_10_active_minus1” and “num_ref_idx_{—}|1_active_minus1” in the syntax of slice header as shown in FIG. 14 are the values indicating “the number obtained by subtracting 1 from the maximum number of candidate reference pictures” in the inter-picture motion estimation. In the case of P slice where the number of pictures which can be simultaneously referred to is 1, “num_ref_idx_{—}|0_active_minus1” is coded into a stream, whereas in the case of B slice where the number of pictures which can be simultaneously referred to is 2, “num ref_idx_{—}|0_active_minus1” and “num_ref idx_{—}|1_active_minus1” are coded into a stream.

As “num_ref_idx_{—}|0_active_minus1” and “num_ref_idx_{—}|1_active_minus1” are the values indicating “the number obtained by subtracting 1 from the maximum number of candidate reference pictures”, even in the case where a value greater than the actually-needed maximum number is set, no problems will occur with regard to decoder's operation (i.e. MPEG standards).

It is therefore possible to overlay the supplementary information (X₀, X₁, X₂, X₃, X₄, X₅, X₆, X₇) onto “num_ref_idx_{—}|0_active_minus1” of eight slice headers as indicated below. Here, Yᵢ shall be a value greater than or equal to a value to be originally coded as “num_ref_idx_{—}|0_active_minus1” for the i th slice.

\textcircled{1} When the supplementary information Xᵢ (i is an integer between 0 and 7) indicates 0, “num_ref_idx_{—}|0_active_minus1” of the i th slice shall be Yᵢ.

\textcircled{2} When the supplementary information Xᵢ (i is an integer between 0 and 7) indicates 1, “num_ref_idx_{—}|0_active_minus1” of the i th slice shall be Yᵢ+1.

Thus, even though the values of “slice_type” of the slice headers of the MPEG stream are different, when the streams except for the slice headers are totally the same, it is obvious that the decoded pictures correspond to each other irrespective of the value indicative of the supplementary information and whether the supplementary information is overlaid or not.

Note that it is defined that “when the supplementary information Xᵢ (i is an integer between 0 and 7) indicates 1, “num_ref_idx_{—}|0_active_minus1” of the i th slice shall be Yᵢ+1”, however, it may be defined that “when the supplementary information Xᵢ (i is an integer between 0 and 7) indicates 1, “num_ref_idx_{—}|0_active_minus1” of the i th slice shall be Yᵢ+a” (a is an integer of two or greater), or if the supplementary information Xᵢ may possibly indicate a value between 0 and N−1, it may be defined that “when the supplementary information Xᵢ (i is an integer between 0 and 7) indicates N, “num_ref_idx_{—}|0_active_minus1” of the i th slice shall be Yᵢ+N”.

The same applies to the case of overlaying the supplementary information onto “num_ref_idx_{—}|1_active_minus1”, as is the case of overlaying the supplementary information onto “num_ref_idx_{—}|0_active_minus1”.

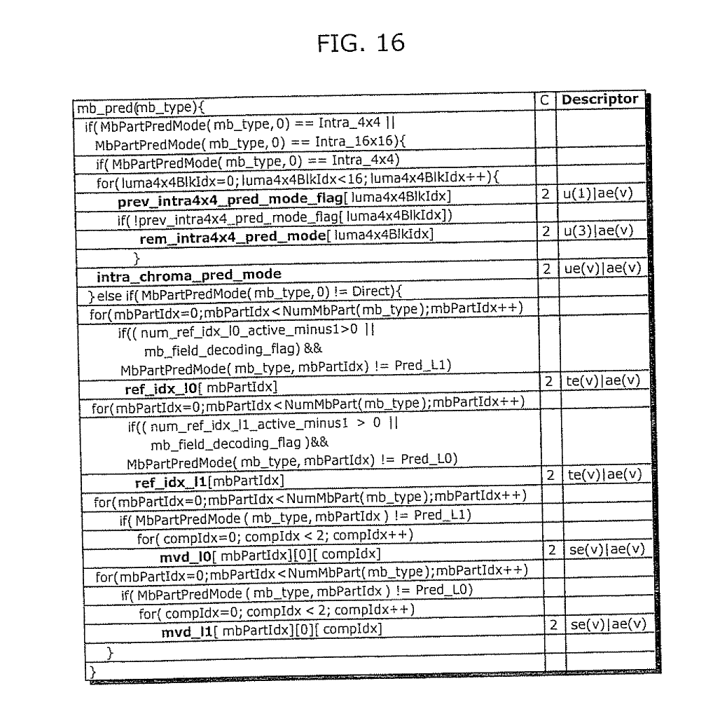

It should be noted that, in the AVC standard, the pictures to be actually referred to on a macroblock basis are specified by “ref_idx_{—}|0” and “ref_idx_{—}|1 shown in FIG. 16. Such coding method varies depending on a value indicating the number of candidate reference pictures specified by “num_ref_idx_{—}|0_active_minus1” and “num_ref_idx_{—}|1_active_minus1”. For example, “ref_idx_{—}|0” changes as in the following.

\textcircled{1} When “num_ref_idx_{—}|0_active_minus1” indicates 0, the number of reference pictures is one at a maximum, therefore, ref_idx_{—}|0 is not to be coded.

\textcircled{2} When “num_ref_idx_{—}|0_active_minus1” indicates 1, the number of reference pictures is two at a maximum, therefore, “ref_idx_{—}|0” is coded by 1 bit.

\textcircled{3} When “num_ref_idx_{—}|0_active_minus1” indicates 2 or greater, “ref_idx_{—}|0” is coded by variable-length coding which assigns a longer code length as “ref_idx_{—}|0” indicates a greater number.

Therefore, in order that the coding method of ref_idx_{—}|0 of the macroblock is not changed, it is recommended to use the value of num_ref_idx_{—}|0_active_minus1 is 2 or greater.

### Fifth Embodiment

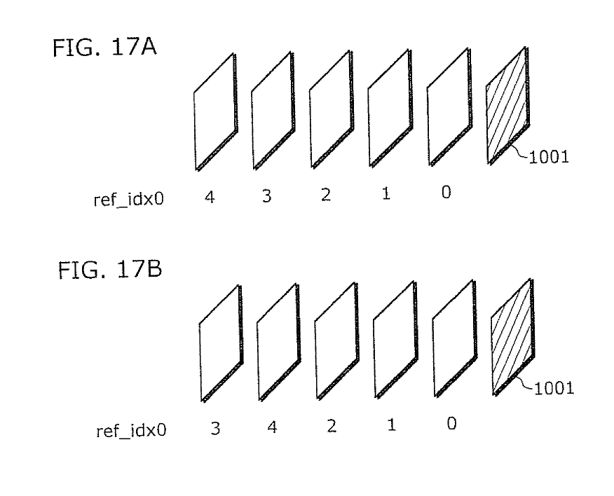

Reference pictures are specified on a macroblock basis by “ref_idx0” or “ref_idx1”, as described above, and FIGS. 17A and 17B show examples of the relationship between “ref_idx0” and the reference pictures. Normally, the more similar a reference picture is to a current picture 1001 to be coded, the stronger the correlation between the pictures becomes, and reference pictures are easily selected for many of the macroblocks. Based on this, the correlation between “ref_idx0” and the reference pictures is assigned as shown in FIG. 17A, and a shorter code length is assigned to “ref_idx0” with a smaller value (that is easily referred to), whereas a longer code length is assigned to “ref_idx0” with a greater value (that is hardly referred to).

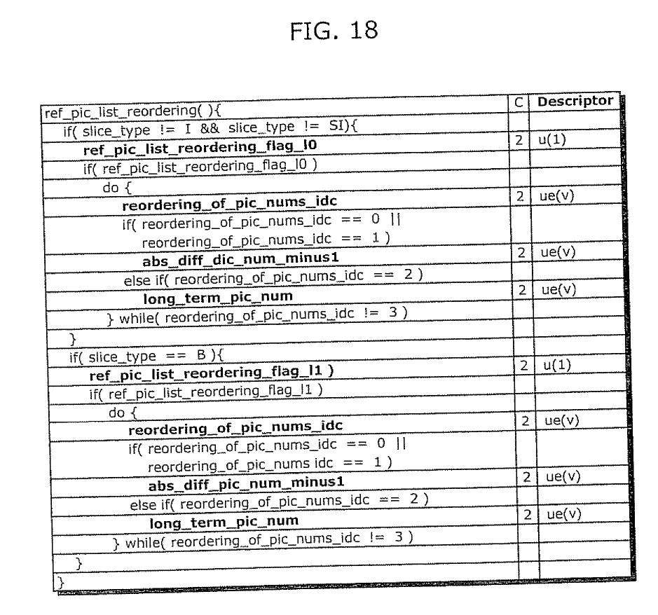

However, there is a case where a distant picture is likely to be selected depending on the image. Based on this, in the MPEG-4 AVC standard, it is possible to assign “ref_idx0” as shown in FIG. 17B. Such mechanism for enabling assignment of different ref_idx0 is a data structure described as “ref_pic_list_reordering( )” in FIG. 14. The detailed data structure of “ref_pic_list_reordering( )” is shown in FIG. 18.

Even by setting the maximum number of reference pictures which can be referred to be greater, there will be no problems with regard to the decoder's operation as well as the MPEG standards. In the case of using “ref_idx0” with any of the numbers 0, 1 and 2, the pictures decoded by a decoder completely matches with each other through either of the assignments of “ref_idx0” as shown in FIGS. 17A and 17B. In the case of changing the assignment of “ref_idx0” with the data structure as shown in FIG. 18, it is possible to change the method of assigning “ref_idx” with the numbers 3 and 4 or the data structure portion for the assignment, according to the supplementary information Xᵢ.

For example, it is possible to overlay the supplementary information Xᵢ by assigning “ref_idx” as follows:

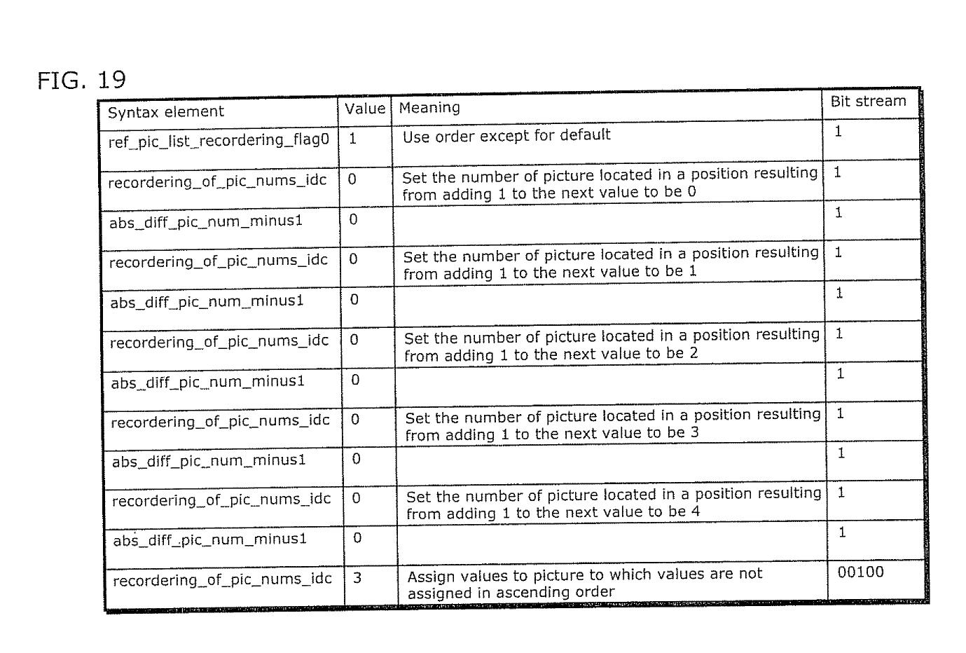

+E,crc, 1 When the supplementary information Xᵢ (i is an integer between 0 and 7) indicates 0, “ref_pic_list_reordering( )” of the i th slice is assigned as shown in FIG. 17A by structuring “ref_pic_list_reordering( )” as shown in FIG. 19.

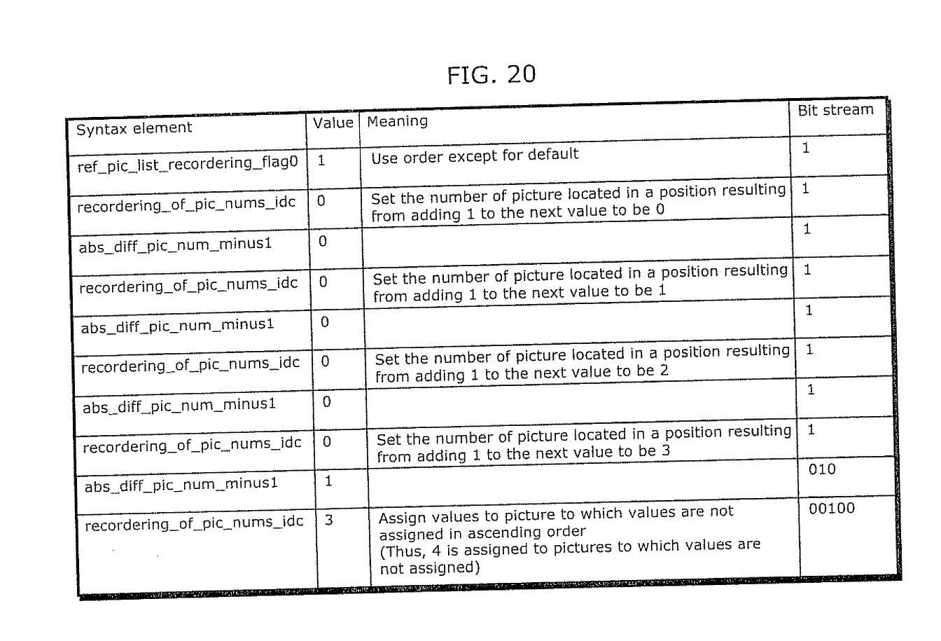

\textcircled{2} When the supplementary information Xᵢ (i is an integer between 0 and 7) indicates 1, “ref_pic_iist_reordering( )” of the i th slice is assigned as shown in FIG. 17B by structuring “ref_pic_list_reordering( )” as shown in FIG. 20.

Note that since the method of coding “ref_pic_list_reordering( )” is very redundant, the method of representing the assignment of “ref_idx0” as shown in FIG. 17A is not limited to one. Therefore, different supplementary information Xᵢ may be assigned in the case where a bit stream itself which represents “ref_pic_list_reordering( )” is different, rather than in the case where the result of the “ref_idx0” assignment based on “ref_pic_list_reordering( )” is different.

### Sixth Embodiment

The sixth embodiment according to the present invention aims to overlay supplementary information X onto an MPEG-2 video stream.

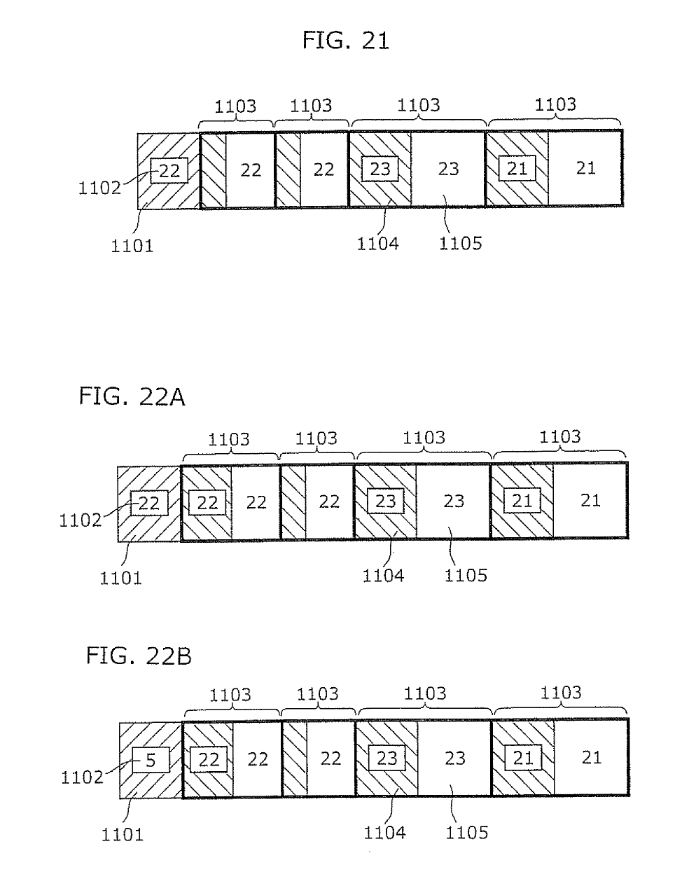

In an MPEG-2 video stream, as shown in FIG. 21, a slice header 1101 and a macroblock header 1104 respectively have a quantiser_scale_code field 1102 which indicates a quantization parameter for deriving a quantization step. The “quantiser_scale_code” has a length of 5 bits and the values ranged from 1 to 31 can be entered.

The value of the quantized parameter specified by “quantiser_scale_code” continues to be used as the quantization parameter of macroblocks until the next “quantiser_scale_code” appears. Therefore, in the case of using the same quantized value for all the macroblocks, a value only needs to be specified once with “quantiser_scale_code” for a slice header, and thus, each macroblock header does not have to hold “quantiser_scale_code”, therefore, the amount of codes can be reduced.

Although the amount of codes increases by an amount equivalent to 5 bits, the macroblock header immediately after a slice header is allowed, grammatically in terms of codes, to have “quantiser_scale_code”. In this case, the specification of quantized parameter performed by “quantiser_scale_code” within the slice header is reset by “quantiser_scale_code” within the macroblock located immediately after the slice header. Therefore, whatever value the quantized value may take, the result of decoding is not affected. Therefore, a code example 1 shown in FIG. 22A and a code example 2 shown in FIG. 22B result in the same meaning in terms of decoding result.

Using the redundancy of codes as described above, the supplementary information Xᵢ is embedded into a stream in the following procedure as shown in FIGS. 22A and 22B.

\textcircled{1} Generate in advance a stream that has “quantiser_scale_code” within the macroblock located immediately after the slice header,

\textcircled{2} Rewrite “quantiser_scale_code” within the slice header and embed desired information.

\textcircled{3} Compare the generated stream with the original stream, extract the rewritten “quantiser_scale_code”, so as to read the embedded information.

With the above method, it is possible, using any kind of decoder, to perform reproduction with a little amount of processing, without affecting the quality of the stream, as well as to embed the supplementary information Xᵢ in such a manner that the embedment is hardly recognized by a copyright infringer or the like.

In the case where a picture with a vertical resolution of 1080 allows one macroblock line to have one slice header, and also allows the macroblock located immediately after all the slice headers to have “quantiser_scale_code”, and embeds the supplementary information Xᵢ into “quantiser_scale_code” within ail the slice headers, it is possible to embed the supplementary information Xᵢ as much as 340 bits per picture since it is possible to overlay the information of 5 bits onto each of 68 slices obtained by dividing the total number of slices 1080 by 16.

Note that the supplementary information Xᵢ may be embedded using only a part of bits instead of embedding the information Xᵢ into all the bits presenting “quantiser_scale_code” within the slice header. For example, a value (e.g. average of quantized values) approximate to a quantized value frequently used within the picture (or slice) into which the information is to be embedded may be set for upper bits, and the supplementary information Xᵢ may be embedded only into lower bits. By applying such method, “quantiser_scale_code” within the slice header becomes approximate to the value that is actually used for the quantization, not an odd value such that is not normally used in that picture (or slice). Therefore, it becomes much harder for a copyright infringer to recognize the embedment of the supplementary information Xᵢ, and thus, it is possible to prevent the supplementary information Xᵢ from being deleted by the copyright infringer.

In the aforementioned case, the number of bits for embedding the supplementary information Xᵢ can be increased or decreased depending on the size of the value indicative of the frequently-used quantized value per picture, per picture or per slice. For example, in the case of embedding the supplementary information Xᵢ using 2 bits when the average value of the frequently-used quantized values is 22, the value possibly indicated is 22, 23, 24 or 25, which gives any odd impression. However, in the case of embedding the supplementary information using 2 bits when the average quantized value is 4, the value possibly indicated is 4, 5, 6 or 7, which gives somehow odd impression. In such case, when the average quantized value is as small as 4, it is possible to control so as to limit the number of bits for embedding the supplementary information to 1 bit, so that the possibly indicated value is 4 or 5, odd impression can be overcome, and thus it becomes much harder to recognize the embedment.

In stead of embedding the supplementary information directly into a bit field, the supplementary information may be expressed by an increase or a decrease based on the quantized value of the original slice. According to the aforementioned example, in the case where the average quantized value is 22, the representation such as 20, 21, 22, 23 and 24 may be modified so that the supplementary information may be represented by the difference based on 22, that is, −2, −1, 0, +1 and +2. By applying such method, odd impression can be further overcome.

Moreover, the bits to be modified may be limited to the minimum (e.g., 1 bit), and the slices to be modified and the slices not to be modified may be selected. In this case, the supplementary information Xᵢ may be represented by the positional relationship between the slices having their bits modified and the slices having their bits unmodified, rather than embedding the supplementary information Xᵢ directly into a slice.

Furthermore, the information may be embedded only into a part of the slice header rather than into “quantiser_scale_code” within all the slice headers. For example, most of the slices shall not have “quantiser_scale_code” in the macroblock located immediately after the slice, as intended by the original MPEG-2 standard, and applies the same embodiment as the MPEG-2 video stream which is generally distributed. Thus, it is possible to allow the part of the slice to have “quantiser_scale_code” in the macroblock header located immediately after the slice header, and the supplementary information Xᵢ is written only into such slice. With such implementation, since at a glance nothing seems to be different compared with the generally-distributed MPEG-2 video stream, it is possible to produce a special effect that it becomes harder for a copyright infringer to recognize the embedment of the supplementary information Xᵢ. In such case, restricting, on a picture or GOP basis, the frequency at which the slice having “quantiser_scale_code” appears in the macroblock immediately following the slice header to a predetermined number or lower, or determining the apparition position by a random number further eliminate unnaturalness, and thus it becomes much harder to perceive the presence of the supplementary information Xᵢ.

Needless to say, each of the varied methods described above may be implemented alone, or it is further effective by combining the methods.

As described above, by successfully overlaying the supplementary information onto specified data of the header of the MPEG stream, it is possible to overlay the supplementary information in such a manner that the complete matching between the picture obtained by decoding the MPEG stream onto which the supplementary information is overlaid onto the header and the picture obtained by decoding the MPEG stream before the supplementary information is overlaid into the header is guaranteed.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A bit stream generation method for generating a bit stream, said method comprising:
creating transformation information indicating a position for overlaying, onto a first bit stream resulting from coding of data, respective bits of supplementary information which is a bit string, the position being a position at which it is determined whether or not data is to be replaced, according to the respective bits of the supplementary information; and
generating a second bit stream by adding the generated transformation information to the first bit stream.

2. The bit stream generation method according to claim 1,
wherein said creating of the transformation information includes:
specifying replacement data per position by analyzing a data structure of the first bit stream, the replacement data replacing data in accordance with the position and the supplementary information, and having a code length which does not change through the replacement; and
creating the replacement data and the information indicating the specified position, as the transformation information.

3. The bit stream generation method according to claim 2,
wherein the first bit stream is variable-length coded,
said creating of the transformation information includes specifying a position, in variable-length coding, of coded data having a same run length, a different level and a same code length is specified as the position, by analyzing a data structure of the first bit stream, and
said specifying of the replacement data includes specifying, as the replacement data, coded data of a same run length, a different level and a same code length as compared with the coded data located in the specified position.

4. The bit stream generating method according to claim 2,
wherein the first bit stream is variable-length coded,
said creating of the transformation information includes
specifying a position, in variable length coding, of coded data having a same level, a different run length and a same code length, as the position by analyzing the data structure of the first bit stream, and
said specifying of the replacement data includes
specifying, as the replacement data, coded data having a same level, a different run length and a same code length as compared with the coded data located in the specified position.

5. The bit stream generation method according to claim 1,
wherein said generating of the second bit stream includes:
changing a stuff bit to a longer stuff bit, the stuff bit being added to a predetermined unit including the position so that the predetermined unit reaches a pre-set code length; and
generating the second bit stream by adding the changed first bit stream to the transformation information.

6. The bit stream generation method according to claim 1,
wherein said creating of the transformation information includes
specifying, as the position, a predetermined unit which includes a stuff bit of a predetermined threshold or greater, by analyzing a data structure of the first bit stream, the stuff data being added so that the predetermined unit reaches a pre-set code length, and
said generating of the second bit stream includes
creating information indicating the specified position, as the transformation information.

7. A bit stream generation apparatus which generates a bit stream, said apparatus comprising:
a transformation information creation unit operable to create transformation information indicating a position which is a position for overlaying, onto a first bit stream resulting from coding of data, respective bits of supplementary information that is a bit string, the position being a position at which it is determined whether or not data is to be replaced, according to the respective bits of the supplementary information; and
an adding unit operable to generate a second bit stream by adding, to the first bit stream, the transformation information is created by said transformation information creation unit.

8. A program for generating a bit stream, the program causing a computer to execute:
creating transformation information indicating a position for overlaying, onto a first bit stream resulting from coding of data, respective bits of supplementary information which is a bit string, the position being a position at which it is determined whether or not data is to be replaced, according to the respective bits of the supplementary information; and
generating a second bit stream by adding, to the first bit stream, the transformation information created by said transformation information creation unit.

9. A storage medium in which a bit stream is stored,
wherein transformation information indicating a position is further stored, the position being a position for overlaying, onto a first bit stream resulting from coding of data, respective bits of supplementary information which is a bit string, and being a position at which it is determined whether or not data is to be replaced, according to the respective bits of the supplementary information.
